(19) United States
(12) Patent Application Publication
(10) Pub. No.: US 2014/0154926 A1
(43) Pub. Date: Jun. 5, 2014

(54) ELECTRONIC CARD CONNECTOR AND ELECTRONIC DEVICE USING THE SAME

(71) Applicants: Hon Hai Precision Industry Co., Ltd., New Taipei (TW); Fu Tai Hua Industry (Shenzhen) Co., Ltd., Shenzhen (CN)

(72) Inventor: YAN-BANG CAO, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/972,866

(22) Filed: Aug. 21, 2013

(30) Foreign Application Priority Data
Dec. 4, 2012 (CN) 2012105121107

(51) Int. Cl. H01R 12/70

(52) U.S. Cl. CPC H01R 12/7058
USPC 439/634

(57) ABSTRACT

An electronic card connector for adapting an electronic card is provided. The electronic card connector includes a locking member having a block. The block can be received in a notch of a tray accommodating an electronic card, thereby holding the electronic card in position. The electronic card connector further includes a elastic ejection member to eject the tray out when the block disengages from the notch of the tray. The tray moves in a first direction, and the block moves in a second direction that is substantially perpendicular to the first direction.

### BACKGROUND

1. Technical Field

The present disclosure relates to an electronic card connector.

2. Description of Related Art

Many portable electronic devices such as cell phones and tablet computers include a card connector for adapting an electronic card, such as a flash memory card. Many types of electronic card connectors have been proposed. However, an electronic device including a new card connector is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an electronic device according to one embodiment.

FIG. 2 a partial view of the electronic device of FIG. 1 showing a card connector located within the housing of the electronic device.

FIG. 3 is similar to FIG. 2, viewed from a different view point, with a tray pulled out of the housing of the electronic device.

FIG. 4 is an isometric, exploded view of the card connector of FIG. 2.

FIG. 5 is planar, top view of the card connector of FIG. 2.

FIG. 6 is isometric, bottom view of the card connector of FIG. 2.

### DETAILED DESCRIPTION

Embodiments of the present disclosure will be described with reference to the accompanying drawings.

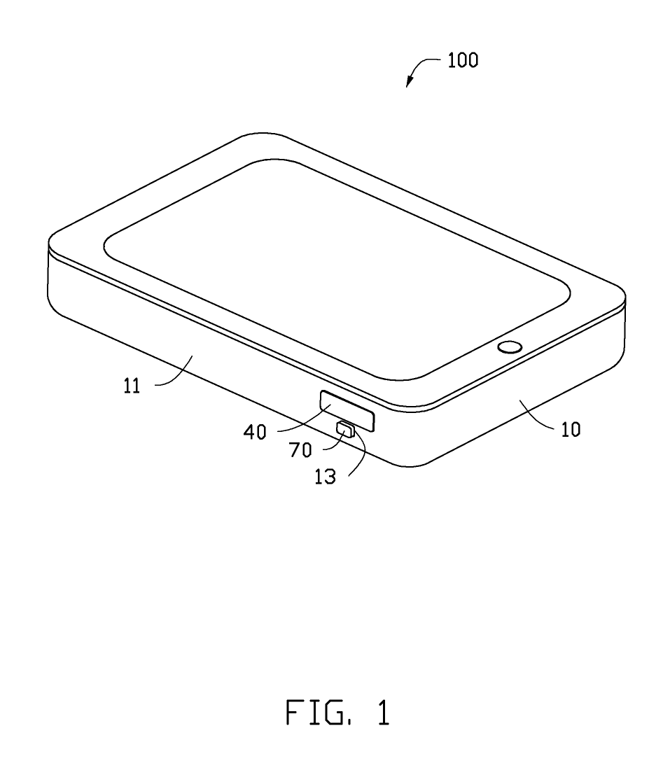

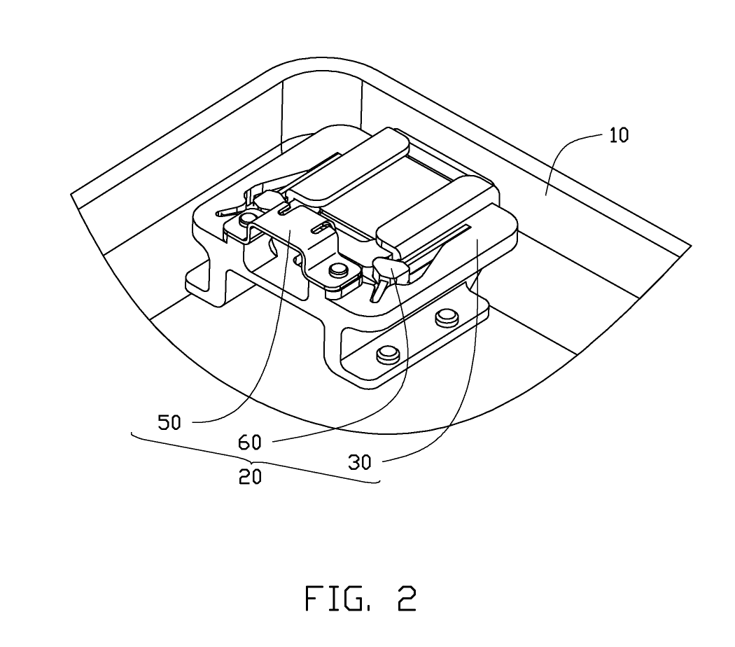

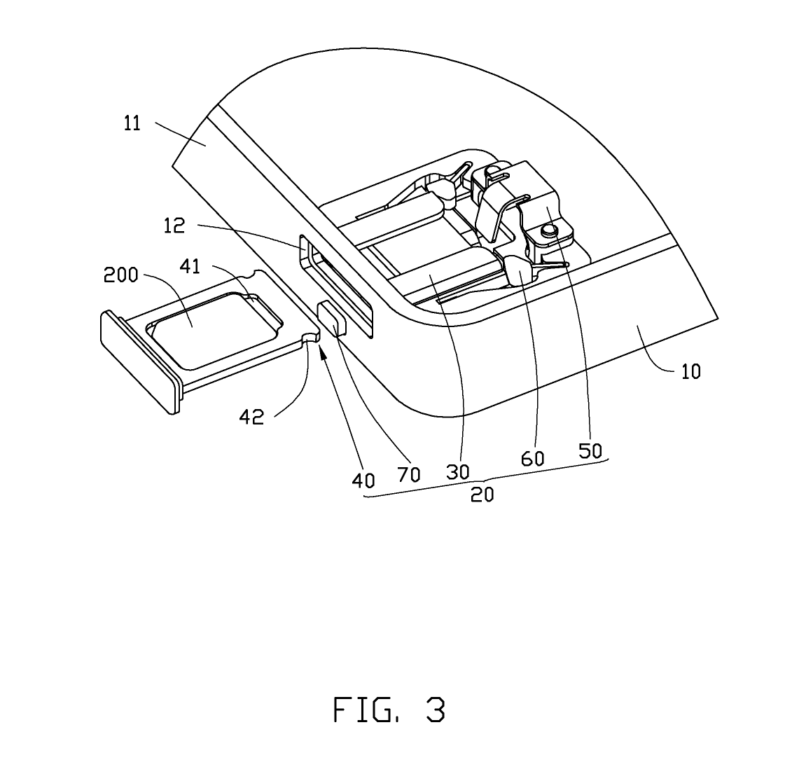

Referring to FIGS. 1-3, an electronic device 100 includes housing 10 and an electronic card connector 20 that is used to adapt an electronic card 200, such as a flash memory card or a subscriber identity module (SIM) card. The electronic card connector 20 includes a main body 30 secured within the housing 10, and a tray 40 slidably connected to the main body 30. The tray 40 defines a recess 41 to receive the electronic card 200, and can be inserted into the housing 10 through a slot 12 defined in a sidewall 11 of the housing 10.

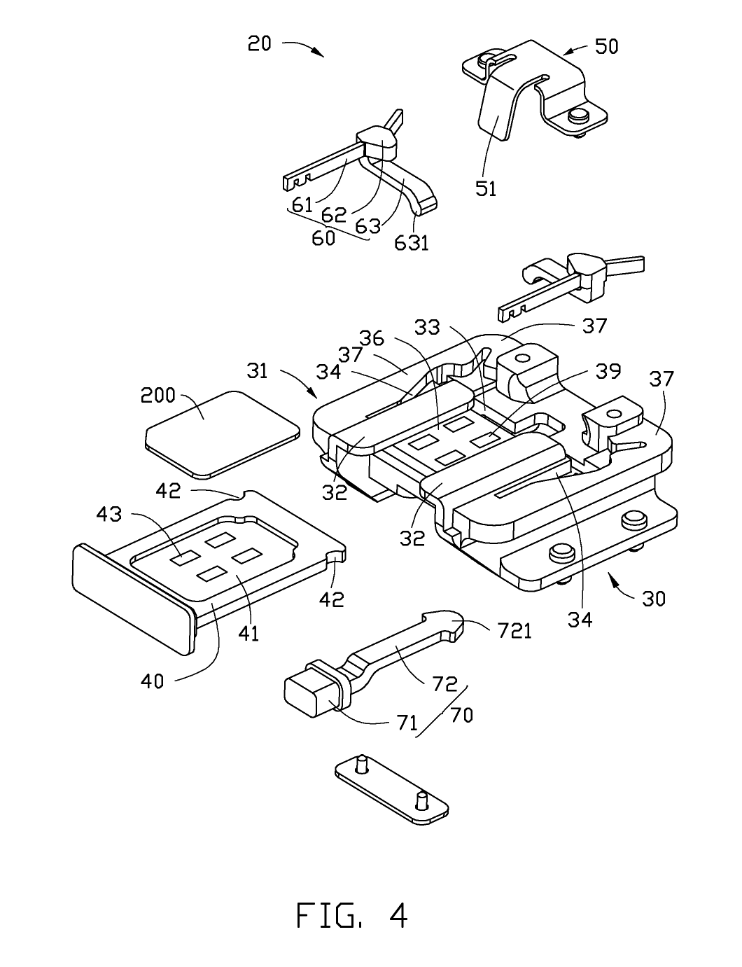

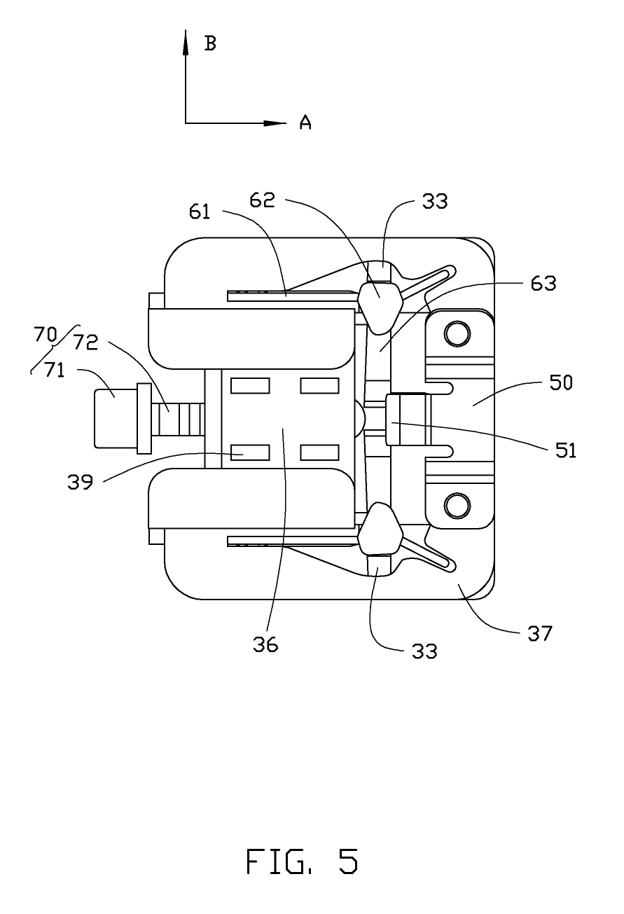

Referring to FIGS. 4-5, the connector 20 further includes an elastic ejection member 50, a locking member 60, and a pushing member 70. A first, top side 31 of the main body 30 includes a guiding member 32 and defines a through hole 33. The guiding member 32 is used to guide the tray 40 to slide along a first direction (indicated by arrow A of FIG. 5) into the housing 10. The elastic ejection member 50 is used to apply a pushing force to the tray 40.

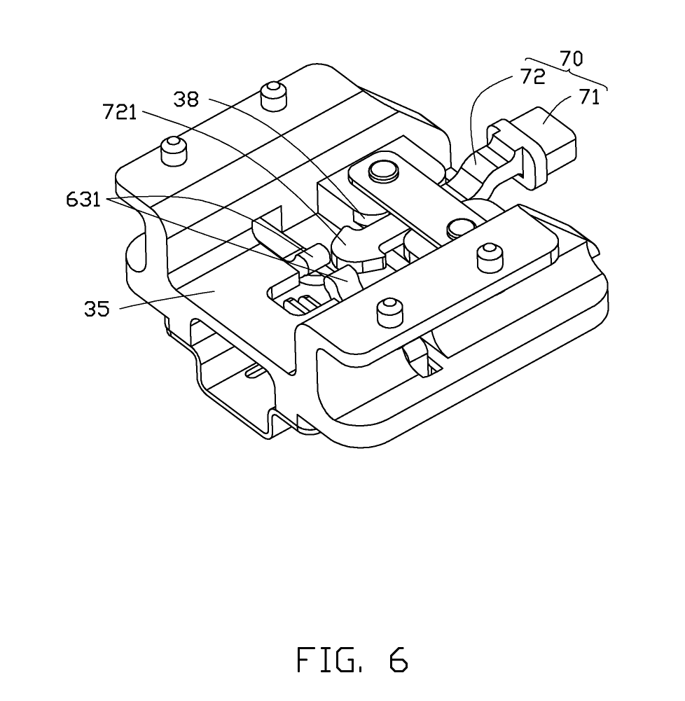

The locking member 60 includes a resilient portion 61, a block 62, and a protruding arm 63. The resilient portion 61 and the protruding arm 63 protrude from the block and extend in different directions. The resilient portion 61 is secured in a receiving space 34 of the main body 30. The block 62 can be received in a notch 42 defined in one side of the tray 40, thereby holding the tray 40 in position. The protruding arm 63 passes through the through hole 33 of the main body 30, and includes a free end 631 (FIG. 6) protruding from a second, lower side 35 of the main body 30.

Referring to FIG. 6, the pushing member 70 is slidably connected to the main body 30, and located at the lower side 35 of the main body 30. The pushing member 70 includes a button 71 received in an opening 13 defined in the sidewall 11, and a shank 72 connected to the button 71. The shank 72 is slidable in a groove 38 defined at the lower side 35. The shank 72 includes a distal end 721 that is used to contact the free end 631 of the protruding arm 63. The distal end 721 and the free end 631 are configured in such a way that the protruding arm 63 is able to move along a second direction (indicated by arrow B of FIG. 5) when the pushing member 70 moves inward along the first direction, thereby causing the block 62 to disengage from the notch 42 of the tray 40. In the embodiment, the distal end 721 is arc-shaped. The tray 40 then moves outward as driven by the pushing force of the elastic ejection member 50. A user can then remove the card 200 from the tray 40. In the embodiment, the first direction and the second direction are perpendicular to each other.

In the embodiment, the top side 31 of the main body 30 includes a first surface 36 and a second surface 37 that is higher than the first surface 36. The guiding member 32 includes two angled portions protruding from the first surface 36. The guiding member 32 and the first surface 36 cooperatively define a space to receive the tray 40. The tray 40 can slide on the firs surface 36 as guided by the guiding member 32. In other embodiments, the guiding member 32 may be a groove formed in the first surface 36, and include two opposite sidewalls to guide the tray 40.

In the embodiment, the through hole 33 is defined in the first surface 36, and extends along the widthwise direction of the main body 30. The extending direction of the through hole 33 is substantially perpendicular to the first direction. The receiving space 34 is defined in the second surface 37 and includes an opening that communicates the receiving space 34 with the through hole 33.

In the embodiment, the elastic ejection member 50 includes a spring tab 51. The spring tab 51 is elastically deformed as driven by the tray 40 that is inserted into the housing 10. After the block 62 disengages from the notch 42 of the tray 40, the spring tab 51 rebounds and pushes the tray 40 to move outward. In other embodiments, the elastic ejection member 50 may be a coil spring.

In the embodiment, the top side and the bottom side of the tray 40 include a number of metal contacts 43, and the first surface 36 includes a number of metal contacts 39 that is electrically connected to the circuit board within the housing 10. The metal contacts 43 on the top side of the tray is used to make a contact with the conductive terminals of the electronic card 200, and the metal contacts 43 on the bottom side is used to make a contact with the metal contacts 39. The electronic card 200 is thus electrically connected to the circuit board of the housing 10 by the engagement of the metal contacts 39 and 43.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. An electronic card connector for receiving an electronic card, comprising:
a slidable tray defining a recess to receive an electronic card, the slidable tray defining a notch in one side thereof; and
a main body defining a through hole and comprising a guiding member at a top side thereof, the guiding member being configured to guide the slidable tray to slide along a first direction, the top side defining a receiving space;
an elastic ejection member secured to the top side of the main body, and configured to apply a pushing force to the electronic card;
a locking member comprising a resilient portion, a block, and a protruding arm, the resilient portion and the protruding arm protruding from the block and extending in different directions, the resilient portion being secured in the receiving space of the main body, the block being configured to be received in the notch of the tray, thereby holding the tray in position, the protruding arm passing through the through hole of the main body, and comprising a free end protruding from a lower side of the main body; and
a pushing member slidably connected to the main body, and located at the lower side of the main body, the pushing member comprising a distal end that is configured to contact the free end of the protruding arm, the distal end and the free end being configured in such a way that the protruding arm is movable along a second direction when the pushing member moves inward along the first direction, thereby causing the block to disengage from the notch of the tray.

2. The electronic card connector according to claim 1, wherein the top side comprises a flat surface, and the guiding member comprises two opposite angled portions.

3. The electronic card connector according to claim 1, wherein the distal end of the pushing member is arc-shaped.

4. The electronic card connector according to claim 1, wherein the first direction and the second direction are perpendicular to each other.

5. An electronic device comprising:
a housing defining a slot and an opening in one side thereof; and
a slidable tray defining a recess to receive an electronic card, the slidable tray defining a notch in one side thereof; and
a main body defining a through hole and comprising a guiding member at a top side thereof, the guiding member being configured to guide the slidable tray to slide along a first direction, the top side defining a receiving space;
an elastic ejection member secured to the top side of the main body, and configured to apply a pushing force to the electronic card;
a locking member comprising a resilient portion, a block, and a protruding arm, the resilient portion and the protruding arm protruding from the block and extending in different directions, the resilient portion being secured in the receiving space of the main body, the block being configured to be received in the notch of the tray, thereby holding the tray in position, the protruding arm passing through the through hole of the main body, and comprising a free end protruding from a lower side of the main body; and
a pushing member passing through the opening of the housing and slidably connected to the main body, the pushing member being located at the lower side of the main body, the pushing member comprising a distal end that is configured to contact the free end of the protruding arm, the distal end and the free end being configured in such a way that the protruding arm is able to move along a second direction when the pushing member moves inward along the first direction, thereby causing the block to disengage from the notch of the tray.

6. The electronic device according to claim 5, wherein the top side comprises a flat surface, and the guiding member comprises two opposite angled portions.

7. The electronic device according to claim 5, wherein the distal end of the pushing member is arc-shaped.

8. The electronic device according to claim 5, wherein the first direction and the second direction are perpendicular to each other.
